(19) United States
(12) Patent Application Publication
(10) Pub. No.: US 2005/0150079 A1
(43) Pub. Date: Jul. 14, 2005

(54) Hinge for a glass door

(76) Inventor: Lothar Ginzel, Schwerte (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/509,792

(22) PCT Filed: Oct. 21, 2003
(86) PCT No.: PCT/EP03/11661

(30) Foreign Application Priority Data
Oct. 23, 2002 (DE) 102 49 537.8

(51) Int. Cl. E05D 5/02

(52) U.S. Cl. 16/252

(57) ABSTRACT

A door hinge includes a body received in a cutout provided in the edge of a glass door, a pair of plates which grip the glass door and hold the body in the cutout, and lights on an edge of the body received in the cutout.

The invention is directed to a fitting for a glass door.

Fittings for glass doors are sufficiently well known. As a rule, they comprise a strip tab and a counterplate, the glass door being received and held between the two. However, these conventional fittings offer few possibilities for improving their visual appearance.

DE 39 01 395 A1 describes a swiveling door for shower cubicles using a swiveling door in which door cutouts are provided for hinges that are to be fitted horizontally.

A door handle provided with lighting means is disclosed in DE 299 06 699 U1. Power is supplied to the lighting means by a low-voltage system.

Therefore, it is the object of the present invention to provide a fitting with an improved visual effect.

This object is met by the features indicated in patent claim 1. Advantageous developments of the subject matter of patent claim 1 are indicated in the subclaims.

Providing the fitting with lighting means results in optical effects which enliven the fitting and which make it possible to adapt to different room conditions on an individual basis.

According to an advantageous further development, the glass door is provided with a glass cutout in which the fitting engages, and the lighting means are arranged in the glass cutout. This makes it possible for the light of the lighting means to radiate in the plane of the glass door and generates a discrete and pleasant illumination.

In a preferred construction, the lighting means are arranged at the front edge of the fitting. In addition or alternatively, the lighting means can also be provided on the upper side and/or on the lower side of the fitting. This results in a large number of design possibilities allowing a large scope for architectonic designs.

The lighting means can be arranged in a particularly simple manner according to an advantageous further development in that the lighting means are received in a cavity formed between the glass cutout and the fitting. Accordingly, the lighting means are effectively protected from external influences and are held securely.

In order to protect against external influences and also to insulate the fitting, which may possibly be formed of conductive material, the cavity is preferably completely or partially filled with an electrically insulating seal.

The lighting means are advantageously formed as LEDs or the like. However, other lighting means with a low energy requirement can also be used.

The LEDs are connected to a control and power supply for supplying power and controlling.

Further details, features and advantages of the invention are indicated in the following description of preferred embodiment examples with reference to the drawings.

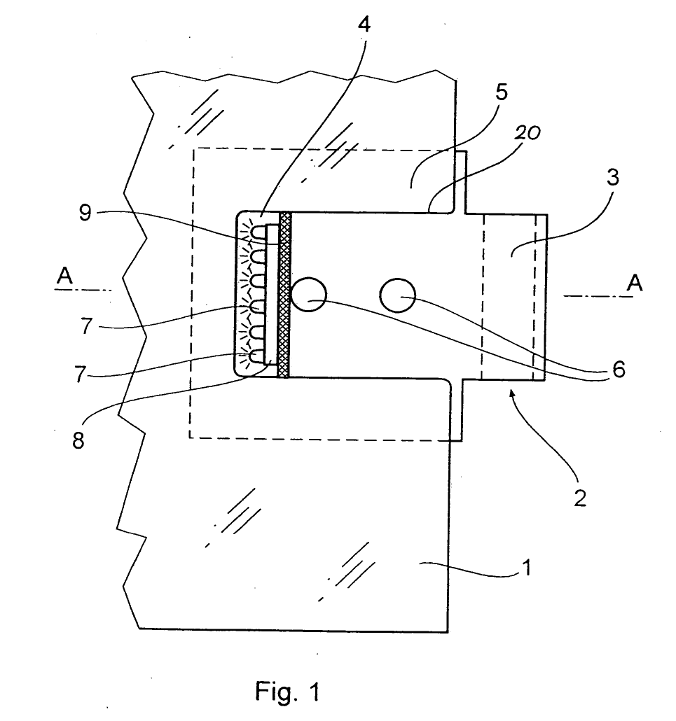

FIG. 1 is a side view of a fitting according to the invention in a first embodiment form;

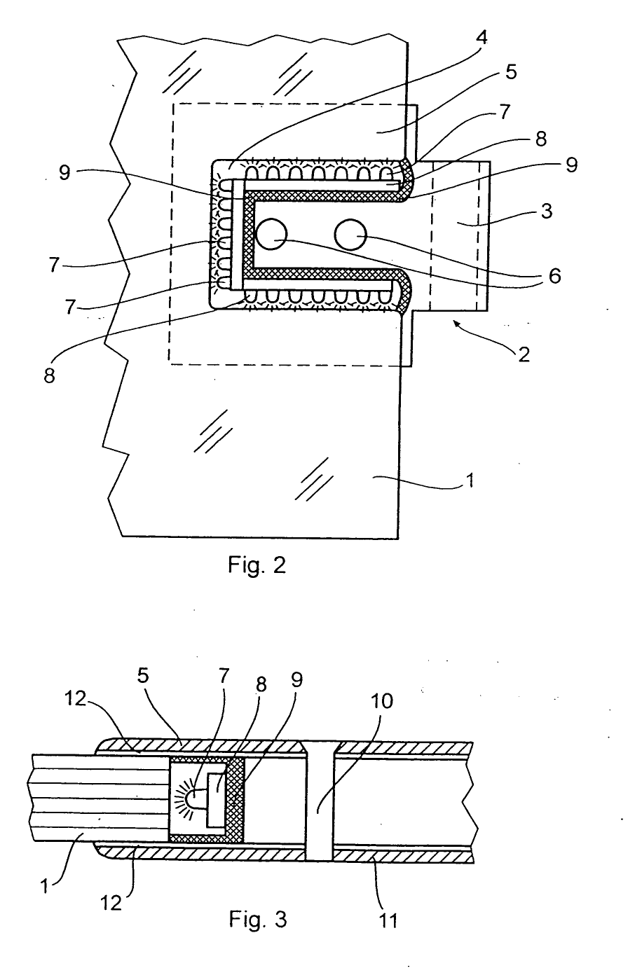

FIG. 2 is a side view of a fitting according to the invention in a second embodiment form;

FIG. 3 shows a section along line A-A in FIG. 1.

A side view of a glass door 1 is shown in FIGS. 1 and 2 in connection with a fitting 2 according to the invention. The fitting 2 is inserted in a glass cutout 4 of the glass door 1 and encloses the glass door 1 laterally by a strip tab 5 and a counterplate 11. Corresponding fastening bore holes 6 are introduced in the strip tab 5 and counterplate 11. These fastening bore holes 6 are penetrated by a connection element 10 and clamp the strip tab 5 and counterplate 11 together in order to hold the glass door 1. A glass protector 12 is arranged between the strip tab 5, counterplate 11 and glass door 1.

At the part projecting out of the glass cutout 4, the fitting 2 is provided with a bore hole 3 for fastening the fitting 2.

A cavity in which lighting means in the form of LEDs 7 are provided is formed between the fitting 2 and the glass cutout 4 in the glass door 1. These LEDs 7 radiate their light in the glass cutout 4 in such a way that the light enters the plane of the glass door 1. The LEDs 7 are provided with a board 8 on the side facing the fitting 2. Further, the cavity remaining between the fitting 2 and the glass cutout 4 is filled with an electrically insulating seal 9.

FIG. 1 shows a first embodiment form of the fitting according to the invention. In this embodiment form, the LEDs 7 are provided only on the front side of the fitting 2.

Another embodiment form of the fitting 2 according to the invention is shown in FIG. 2. In this embodiment form, a plurality of LEDs 7 are provided which are arranged not only at the front side of the fitting 2 but also at its upper side and lower side.

The LEDs 7 can be provided with an additional circuit which makes it possible to vary the light radiated by the LEDs 7 with respect to duration of illumination, brightness and/or color mixture. Further, the LEDs 7 can be controlled depending on incident daylight, depending on the presence of a person, or according to any other program.

Reference Numbers
1 glass door
2 fitting
3 bore hole
4 glass cutout
5 strip tab
6 fastening bore hole
7 LED
8 board
9 electrically insulating seal
10 connection element
11 counterplate
12 glass protection

1-7. (canceled)

8. A fitting for a glass door provided with a cutout, the fitting comprising:
a body which can be received in the cutout, the body having opposed sides and a front edge;
a strip tab and a counter plate which can be fixed to respective said sides of the body in order to grip the glass door and hold the body in the cutout; and
lights arranged on the body so that the lights can be received in the cutout.

9. The fitting according to claim 8 further comprising lights arranged on the front edge.

10. The fitting according to claim 8 wherein the fitting has an upper edge and a lower edge, the lights comprising lights arranged on at least one of the upper edge and the lower edge.

11. The fitting according to claim 8 wherein the fitting and the cutout form a cavity, the lights being received in the cavity.

12. The fitting according to claim 8 further comprising an electrically insulating seal between the body and the lights.

13. The fitting according to claim 8 wherein the lights are LEDs.

14. The fitting according to claim 13 further comprising at least one board to which the LEDs are connected, the board being received between the body and the glass door.
